(19) United States
(12) Patent Application Publication
(10) Pub. No.: US 2008/0047645 A1
(43) Pub. Date: Feb. 28, 2008

(54) TRACTIVE TIRE METHOD AND APPARATUS

(76) Inventors: Jon Stuart Gerhardt, Stow, OH (US); Frank James Jenkins, Tallmadge, OH (US); John Michael O'Brien, Tualatin, OR (US); Ernie Shirey, Barberton, OH (US); Raymond Bryce Bushnell, Beavercreek, OR (US); Danny Robert Lewis, Beavercreek, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/466,844

(22) Filed: Aug. 24, 2006

(51) Int. Cl. B60C 11/00; B29D 30/66

(52) U.S. Cl. 152/210; 156/114

(57) ABSTRACT

Apparatuses, methods, and systems associated with traction devices for vehicle tires are disclosed herein. In various embodiments, a tire may include a tread material bonded with a casing, the tread material having a tread pattern and one or more tractive devices may be disposed within voids in the tread pattern. In some embodiments, a media passage may be disposed between the tread material and the casing substantially under one or more of the voids in the tread pattern, the chambers and/or channels being controllable to urge movement of a corresponding tractive device.

### TECHNICAL FIELD

Embodiments of the invention relate generally to the field of tires, specifically to methods, apparatuses, and systems associated with tractive tire and tractive tire building.

### BACKGROUND

Tires may be manufactured based at least in part on weather conditions in which the tires may be used. For example, some tires may be classified as snow, ice, all-season, or summer tires. Differences between these tires may include variations in tread patterns and/or tire material. Additionally, in some cases, tractive features may be included on the road engaging surface of a tire, typically for snow or ice tires.

Tractive features for snow and ice tires may include studs or stud-like features, fabric, silica, etc. Regarding studs, these devices may cover some portion of a tire to grip and/or roughen up a surface, thereby increasing traction. Generally, studs are implanted into a tire surface by forcing the studs into a cavity or other receptacle drilled or pre-cured into a tread block of the tire. The cavity or other receptacle may be smaller than a base of stud, thereby holding the stud in place.

Although studs have been used for some time and are effective in increasing traction of a tire as compared to a tire having no studs, the studs of a studded tire are in constant engagement with the road, which leads to certain undesirable consequences. For example, studs that are simply forced into pre-cured or drilled cavities may not be held in place tightly enough to avoid dislodging. Additionally, studs in constant engagement with the road may wear and/or dull over time. Still further, studs have been known to cause increased wear on roadways.

Even aside from the foregoing problems, studded tires generally may not be used year-long (according to various state laws) or may be undesirable to use year-long. In either event, a driver may be left without adequate traction should unexpected inclement weather arise and/or may have the burden of swapping out sets of tires at least a couple times a year.

### BRIEF DESCRIPTION OF THE DRAWINGS

Embodiments of the present invention will be readily understood by the following detailed description in conjunction with the accompanying drawings. Embodiments of the invention are illustrated by way of example and not by way of limitation in the figures of the accompanying drawings.

FIGS. 1A and 2A illustrate cross-sectional views of a tire incorporated with the teachings of the present invention, in accordance with various embodiments;

FIG. 2A illustrates a top view of a tire tread incorporated with the teachings of the present invention, in accordance with various embodiments;

FIG. 2B illustrates a cross-sectional view of the tire tread of FIG. 2B incorporated with the teachings of the present invention, in accordance with various embodiments;

FIG. 2C illustrates an isometric top view of a tire tread incorporated with the teachings of the present invention, in accordance with various embodiments;

FIG. 2D illustrates an isometric bottom view of a tire tread incorporated with the teachings of the present invention, in accordance with various embodiments;

FIGS. 3A, 3B, and 3C illustrate a method for forming a tread pattern incorporated with the teachings of the present invention, in accordance with various embodiments;

FIGS. 4A, 4B, and 4C illustrate a method for forming a casing incorporated with the teachings of the present invention, in accordance with various embodiments;

FIGS. 5A and 5B illustrate a cross-sectional view of a tire tread incorporated with the teachings of the present invention, in accordance with various embodiments;

FIGS. 6A, 6B, and 6C illustrate another method for forming a tread pattern incorporated with the teachings of the present invention, in accordance with various embodiments;

FIG. 7 illustrates a tractive device incorporated with the teachings of the present invention, in accordance with various embodiments;

FIGS. 8A, 8B, and 8C illustrate a media management subsystem incorporated with the teachings of the present invention, in accordance with various embodiments; and

FIG. 9 illustrates a cross-sectional view of a tire incorporated with the teachings of the present invention, in accordance with various embodiments.

### DETAILED DESCRIPTION OF EMBODIMENTS OF THE INVENTION

In the following detailed description, reference is made to the accompanying drawings which form a part hereof and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).” The phrase “(A) B” means “(B) or (A B),” that is, A is optional.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

In various embodiments of the present invention, methods, apparatuses, and systems for tractive tires are provided. In exemplary embodiments of the present invention, a tire may comprise a tread material including tread voids and road-engaging surfaces, and further including one or more tractive devices disposed in one or more tread voids. In various embodiments, a media passage including one or more chambers and one or more channels coupling the chambers may be disposed substantially beneath one or more tread voids which, when pressurized, may cause corresponding tractive devices to urge outward to make contact with a road surface.

Tires and/or systems endowed with one or more features described herein may accrue a number of benefits. For example, tires and/or systems in accordance with various embodiments of the present invention may vitiate a need for replacing tire(s) with studded winter tires and/or mounting snow chains during inclement weather. Tires in accordance with various embodiments may be used yearlong and may be desirable for climates and/or driving habits leading to unexpected inclement weather. Still further, tractive devices in accordance with various embodiments of the present invention may be controllable so that the tractive device are urged outward only when needed and/or desired which may result in a tire having a longer life and/or having less wear on roads.

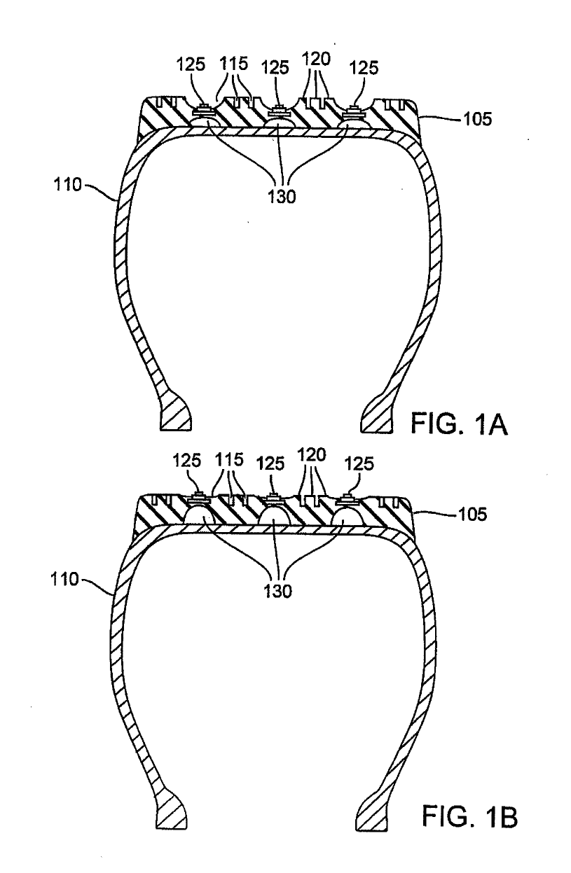

Referring now to FIG. 1A and FIG. 1B, illustrated is a tire in accordance with various embodiments of the present invention. In various embodiments, the tire may comprise tread material 105 and casing 110. Tread material 105 may include tread voids 115 and road-engaging surfaces 120, and may further include one or more tractive devices 125 disposed in one or more voids 115 in tread material 105. In various embodiments, one or more media passages including one or more chambers 130 and one or more channels (not shown) may be disposed between tread material 105 and casing 110. Chamber(s) 130 may be controllable to cause tractive device(s) 125 to be urged outward into a position such that tractive device(s) 125 extends to contact a road surface (as shown in FIG. 1B). In various ones of these embodiments, contact with a road surface by tractive device(s) 125 may increase traction of the tire.

A tire in accordance with various embodiments may be used for any one of a number of vehicle types. For example, the tire may be used for a car, a truck, plane, etc. The tire may be particularly suited for vehicles traveling on terrain wherein increased traction is desired and/or necessary. In exemplary embodiments, the tire may increase traction in snow and/or ice. However, the tire also may be used, as with generally known tires, in situations wherein increased traction is not desired and/or necessary. In these embodiments, tractive device(s) 125 may be in a retracted position such that road-engaging surfaces 120 of tread material 105 bear most or all of the weight of a vehicle.

Regarding road-engaging surfaces 120 and voids 115 of tread material 105, these features may encompass a broad range of features of tread topology, pattern and/or design. For example, road-engaging surfaces 120 of tread material 105 may include a selected one or more of blocks, ribs, and shoulders, depending on the applications. A block may comprise discrete segments of road-engaging surfaces 120. A rib may comprise a row of blocks and may take the form of a circumferential band around the tire. A shoulder may comprise an outer edge of tread material 105 but still being road-engaging. Voids 115 may include a selected one or more of sipes, dimples, grooves, channels and the like depending on the applications. Alternate industry nomenclature for “road-engaging surfaces” and “voids” may exist although not herein listed; however, one skilled in the art will understand the term “road-engaging” and “voids” as herein used in light of generally-known concepts in the tire-manufacturing industry.

Regarding casing 110, it should be noted that alternate industry nomenclature for “casing” may include references such as “carcass” as well as other terms not herein listed; however, one skilled in the art will understand the term “casing” as herein used. In various embodiments, casing 110 may be new, i.e. not previously used, and specifically designed and manufactured to have tread applied thereto in order to build a tire in accordance with various embodiments and/or methods as disclosed herein. In one embodiment, a new casing may have a determined thickness of rubber overlaying the belts, e.g. 2/32 of an inch. Prior to curing, a portion of that rubber, e.g. 1/32 of an inch, may be buffed away or removed to improve the potential for bonding between the tread and the casing. It is believed that no tire build process combines new casings with newly formed tread. Yet, in various other embodiments, casing 110 may be a used casing (i.e., having formerly had a tread material disposed thereon), depending on the applications.

Casing 110 may include any one or more of various components. For example, casing 110 may include one or more of bead(s), body ply(ies), belt(s), and liner(s). In various embodiments, a body ply may comprise polyester. A body ply may be wrapped around a bead, and in some embodiments, one or more body plies may be looped and other ends of the body plies may be wrapped around another bead. In various embodiments, multiple body plies may be looped to form a general shape of the tire, depending on the applications. In various embodiments, a belt may be disposed over body plies for various purposes including, for example, added strength of the tire. In various ones of these embodiments, a belt may comprise steel and/or nylon.

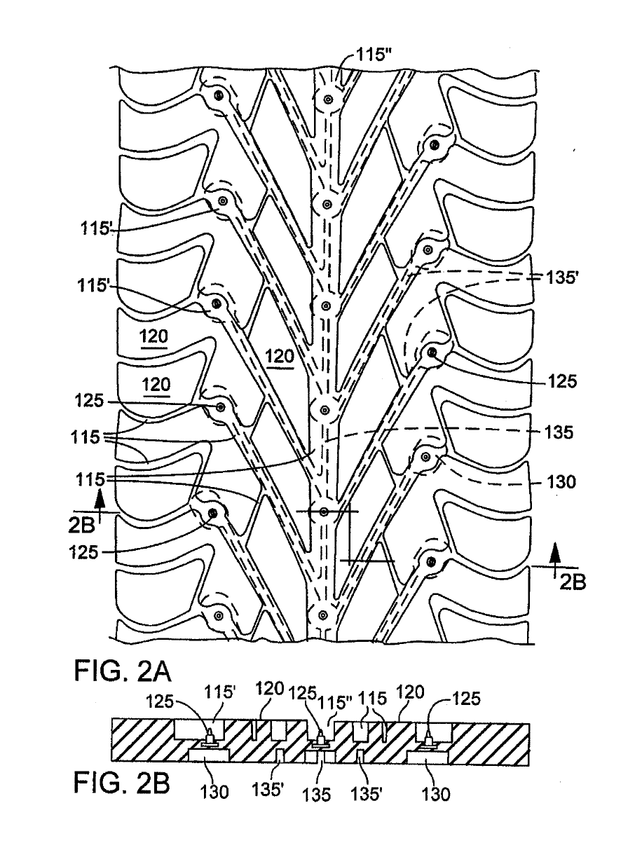

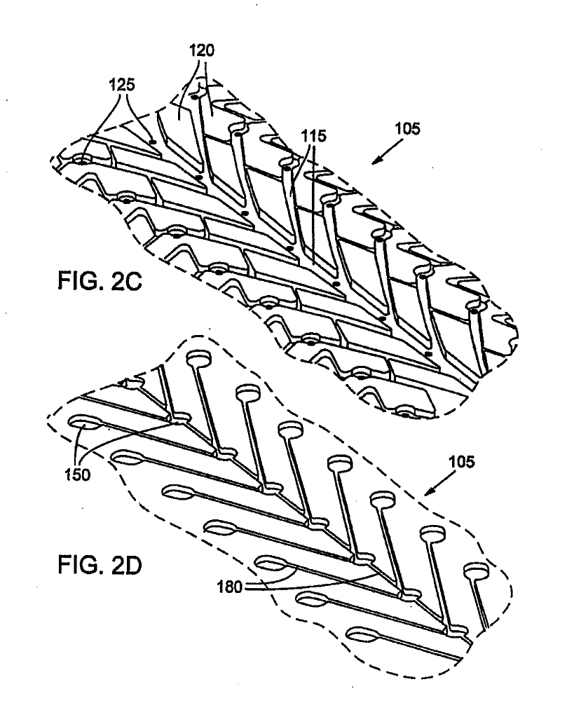

Referring now to FIG. 2A, illustrated is top view of a tire in accordance with embodiments of the present invention. FIG. 2B illustrates a cross-sectional view of the tire (without the casing). In various embodiments, among voids 115, a plurality of tractive-device 125 bearing voids 115′ may be disposed about the circumferential surface of the tread material, both centered and/or off center.

In one embodiment, a media passage including chamber(s) 130 and central media passage/channel(s) 135 may supply air to a central tractive-device 125 bearing void 115″. Additional secondary media passages 135′ may branch off of the central media passage 135 and may be adapted to supply air to the chambers 130 underlying off center tractive-device 125 bearing voids 115′. In various embodiments, off center tractive-device 125 bearing voids 115′ may be coupled to a separate media passage and/or media source.

Turning now to FIG. 2C and FIG. 2D, illustrated are views of the tread material in accordance with embodiments of the present invention. Tread material 105 may be disposed over a casing to form a tire. Tread material 105 may comprise generally-known tread material including, for example, rubber. Still further, in embodiments, tread material 105 may comprise a tread pattern, including road-engaging surfaces 120 and voids 115, as mentioned previously. Tread patterns may comprise one of various patterns, depending on the applications. For example, in embodiments, a tread pattern may be selected for any one or more of various purposes including, for example, aesthetic, tractive, handling, noise-generation, ride comfort, and fuel-efficiency reasons.

As mentioned previously, a media passage including one or more chambers and one or more channels may be disposed between a tread material and a casing. In various embodiments and as shown in FIG. 2D, the back side of tread material 105 may comprise recesses 150 and grooves 180. In various embodiments, one or more of recesses 150 may form one or more corresponding chambers when tread material 105 is coupled to a casing. Similarly, one or more of grooves 180 may form one or more corresponding channels when tread material 105 is coupled to a casing.

In various other embodiments, chamber(s) may be formed by recess(es) in a casing. Similarly, channel(s) may be formed by groove(s) in a casing. In still other embodiments, chamber(s) may be formed by recess(es) in both casing and tread material, and/or channel(s) may be formed by groove(s) in both casing and tread material. In various ones of these embodiments, a recess on the back side of the tread material may be aligned with a corresponding recess in a casing when coupling the tread material with the casing to form one or more of the chambers. Similarly, in various embodiments, a groove on the back side of the tread material may be aligned with a corresponding groove in a casing when coupling the tread material with the casing to form one or more of the channels.

In some embodiments, a tread pattern on tread material 105 may be variously formed. For example, in various embodiments, a tread pattern may be molded into tread material 105. In other embodiments, for example, a tread pattern may result from an extrusion operation. Various other methods not herein listed may alternatively be used to form tread pattern. Similar methods may be used for forming a casing.

In exemplary embodiments, a tread pattern in a tread material may result from compression molding. A tread material may be compression molded by pressing an uncured and/or partially cured tread material between an upper mold and a lower mold. An upper mold may be used to form the tread pattern and lower mold may be used to form a media passage (i.e., one or more chambers and/or channels) on the back side of the tread material. Such a two-sided mold configuration may allow for the media passages to carry air from a media source, for example, to the various tractive-device bearing chamber(s) and/or channels(s). In other embodiments, the back side of the tread may be un-molded, and a secondary operation may be performed to remove material to form recesses and groves. Various exemplary embodiments of upper mold and lower mold are described below.

In other embodiments, a plurality of media passages may be formed, with the plurality of media passages being interconnected or unconnected to others of the plurality of media passages. As discussed previously, as air or other medium charges the media passage(s), one or more chamber(s) and/or channel(s) may expand, thereby causing the corresponding tractive device(s) to be urged outward into a position such that the tractive device(s) may make at least partial contact with a road surface.

It is generally understood that having a separation between the underside of the tread and the casing of the tire can be one of the causes that leads to a tire failure. This is in part due to the fact that the separation may grow as a result of the direct transfer of energy from road-engaging surfaces of the tread to the separation area. While conventional wisdom has been to avoid such separations, in certain embodiments, the media passage(s) essentially create such a separation. In order to reduce the potential for separation-induced failure, in various embodiments, the media passage(s) (i.e., chamber(s) and/or channel(s)) may be disposed substantially beneath corresponding void(s) in a tread pattern of the tread material. So disposed, chamber(s) and/or channel(s) being located substantially beneath void(s) in the tread pattern may result in stasis of the chamber and/or channel size because of little or no direct transfer of energy to that area. In certain embodiments the configuration/pattern of the passages and the chambers may be dictated by the voids in a desired tread pattern and/or vice versa.

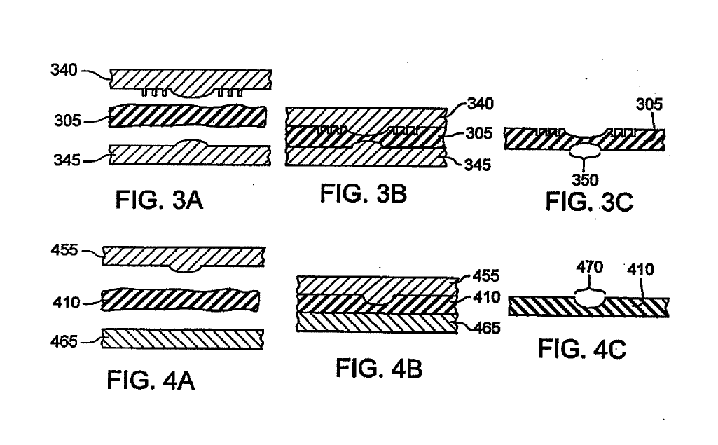

An exemplary embodiment of a method for forming a tread pattern in a tread material is illustrated in FIGS. 3A, 3B, and 3C. In various ones of these embodiments, tread material 305 may be formed by compression molding tread material 305 between upper mold 340 and lower mold 345 for a time and at a temperature sufficient to result in a tread pattern in tread material 305. One or both of upper mold 340 and lower mold 345 may include a tread pattern formed therein, and a tread pattern may be formed in tread material 305 as a result of a negative pattern disposed in one or both of upper mold 340 and lower mold 345, as shown. In various embodiments, tread material 305 may comprise rubber and in various ones of the embodiments, tread material 305 may be formed from an uncured rubber and curing the uncured rubber (e.g., by pressing tread material 305 between upper mold 340 and lower mold 345 for a time and at a temperature sufficient to result in a tread pattern in tread material 305).

As mentioned previously, a chamber may comprise a selected one of a recess in a tread material, a recess in a casing, or both. Similarly, a channel may comprise a selected one of a groove in a tread material, a groove in a casing, or both. As shown in FIGS. 3A, 3B, and 3C, for example, lower mold 345 may be configured to form one or more recesses 350, which when the tread material is coupled to the casing may form one or more corresponding chamber(s). In some embodiments, lower mold 345 may be configured to form one or more grooves, which when the tread material is coupled to the casing may form one or more corresponding channel(s) (not shown).

Similarly, and as shown in FIGS. 4A, 4B, and 4C, upper mold 455 and lower mold 465 may be used to form casing 410. In such an embodiment, upper mold 455 may include a pattern disposed therein for forming one or more recesses 470, which when coupled to the tread material, may form corresponding one or more chamber(s). In some embodiments, lower mold 345 may be also be configured to form one or more grooves, which when the casing 410 is coupled to the tread material may form one or more corresponding channel(s) (not shown).

Still further, in various embodiments, both the tread forming molds and the casing forming molds may comprise corresponding patterns disposed therein for forming one or more recesses that may form corresponding one or more chambers and/or passages.

In various embodiments, one or more channels may be formed in a tread material, a casing, or both, for coupling selected chambers to other chambers, and/or to a media source. In various ones of these embodiments, a channel may provide a passage for air (and/or other medium) to move between chambers, depending on the applications. Air (and/or other medium) may control pressure inside a chamber for causing a corresponding tractive device to be urged outward into a position such that the tractive device extends to make at least partial contact with a road surface.

Still referring to chambers and channels, in various embodiments either one or both may dictate a tread pattern for forming into a tread material. However, in various other embodiments, a tread pattern may dictate location of chamber(s) and/or channel(s).

In various embodiments, the size, shape, thickness and/or diameter of the portion of material between the top of a chamber and the bottom portion of the tractive-device bearing voids may be optimized based at least in part on an amount of outward movement desired and/or necessary for a corresponding tractive device to extend a sufficient distance that it may contact the road surface. For convenience, this portion may be generally referred to herein as a “drumhead membrane”, “drumhead” and/or “membrane.” Use of these terms, however, are not intended to refer in any way to the shape or form of the membrane. The tractive device need not protrude past the height of the tread block, though it may if desired, as the deformation of the tire as a result of the weight of the vehicle can cause the tractive device to engage the road surface.

Similarly, in various embodiments, it may be desirable to ensure that a tractive device in an un-expanded position avoids contact with a road surface as a tread material wears down over time. For example, if a tread pattern of a tire has an unworn tread depth of 10/32 inch and is deemed completely worn (i.e. unsafe and/or undesirable to use) at 2/32 inch, then a chamber including a tractive device may have an un-expanded height of no more than 2/32 yet still able to expand a sufficient distance to engage a road surface when the tread is at or close to full tread depth. In various embodiments, in situations wherein the un-expanded height of the tractive device is not sufficiently low enough to avoid contact with a road surface, a chamber beneath the tractive device may allow for some deflection of the drumhead membrane and thus deflection of the tractive device. This deflection helps resist unnecessary wear on the stud as well as damage to the road surface.

In various embodiments, a distance a chamber is able to expand may be based on a number of factors, which directly impact the expansion height of the tractive device. In one embodiment, the expansion distance of the chamber may depend at least in part on the diameter of the drumhead membrane of the chamber. In another embodiment, the expansion distance may depend on the thickness of the drumhead membrane. In various embodiments, the drumhead membrane of a chamber, and/or the chamber itself, may have any one of various un-expanded states, as desired, including, for example, concave, convex, or generally horizontal. Moreover, chamber(s) may be of a variety of geometrical configurations, including, but not limited to circular, square, polygonal, and the like.

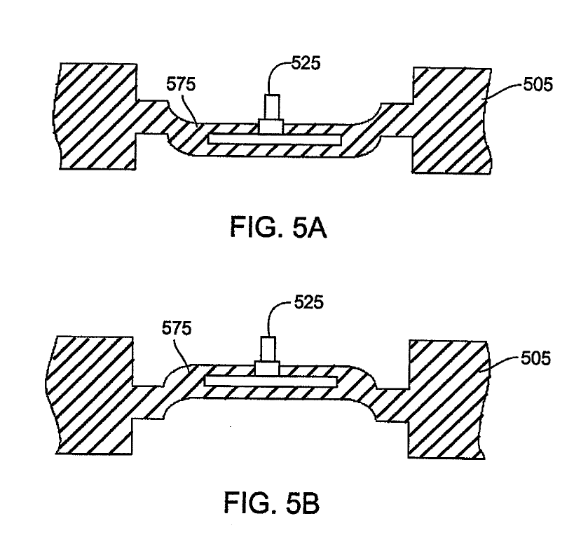

An exemplary embodiment of a concave drumhead 575 is shown in FIG. 5A and FIG. 5B. In these embodiments, the concave shape may allow tractive device 525 to be in lower position relative to a generally horizontal drumhead. Such a position may result in an extended lifetime of a tire due at least in part to increased distance between a top surface of tread material 505 and top of tractive device 525. Still further, in various embodiments, the concave shape may be an equilibrium position such that drumhead 575 and associated tractive device 525 may be urged to retract back into an un-extended position when pressure decreases inside of a chamber below drumhead 575. Further, by being concave, in various embodiments, expansion of the membrane may allow for an even greater extension than a flat or convex membrane.

Turning now specifically to tractive devices, in various embodiments, a tractive device may take any one of a variety of forms. For example, in various embodiments, a tractive device may comprise a stud, a stud-like device, or a commonly known tractive device. Studs may comprise a selected one or more of various materials including, for example, metal and metal-based materials. An exemplary stud material is tungsten carbide. However, in various other embodiments, a tractive device may comprise carbon based materials, various alloys, and/or silica-based materials.

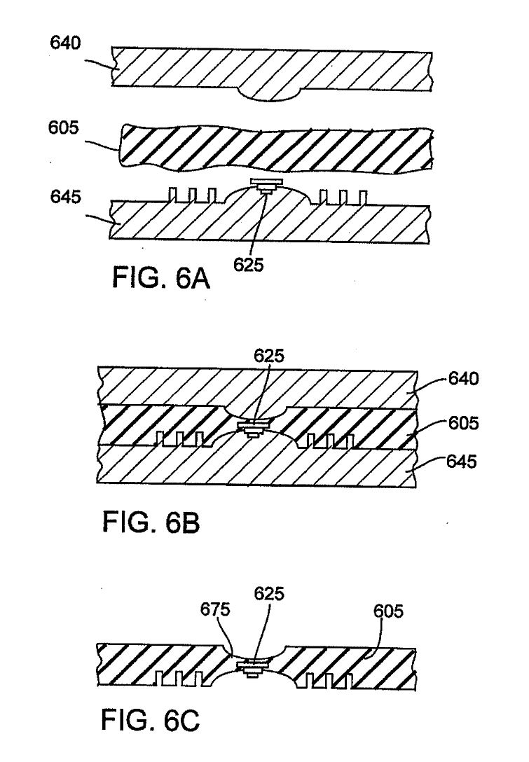

In various embodiments, a tractive device may be coupled with a tread material in such a way that the tractive device is held in place by way of the curing operation of the tread material. In one embodiment, for example and as shown in FIGS. 6A, 6B, and 6C, tractive device 625 may be placed into tread mold 640 for forming a tread pattern and then coupled with drumhead membrane 675 of tread material 605 during a molding of the tread pattern (i.e., tractive device 625 is pressed into tread material 605 and becomes coupled therewith). In various embodiments, the studs may be placed into the mold stud receptors and be held in position generally by gravity and/or the receptor until the tread is formed in the mold.

In some embodiments, prior to molding a tread pattern in tread material 605, tractive device 625 may include an adhesive or other bonding agent disposed thereon which, when tractive device 625 is coupled with tread material 605, may increase a strength of a bond between tractive device 625 and tread material 605. In one embodiment, a bonding agent such as Chemlok® may be used to better secure the tractive material in the tread. In various ones of these embodiments, a bond between tractive device 625 and tread material 605 may result from an interaction occurring between the adhesive or bonding agent and tread material 605 during the curing operation, thereby resulting in a durable bond between tractive device 625 and tread material 605.

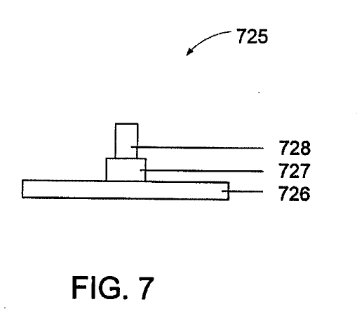

Still further, in various embodiments, a tractive device may be configured to be securely held in place in a tread material. For example and as shown in FIG. 7, tractive device 725 may include a base 726, a stem 727, and a road engaging end 728. In such embodiments, base 726 is generally wider and shorter (relative to stem 727 and road engaging end 728) such that base 726 may be held substantially within a membrane of a tread material (see, e.g., FIG. 6C, tractive device 625 in membrane 675). Base 726 having such a configuration may ensure tractive device 726 stays substantially securely in place, such that a significant area interfaces with the membrane material.

In some embodiments, the road engaging end 628 may be sized to fit in a corresponding aperture of the tread forming mold. Stem 627 may act as a shoulder to limit the depth the road engaging end 628 engages the mold. In other embodiments, the road engaging end and the stem may be of the same or differing diameters.

A tread material, either with or without tractive device(s), may be variously coupled with the casing as part of general methods for making a tire. In various embodiments, a tread material and a casing may each be cured separately, placing uncured rubber, such as cushion gum, between the cured tread material and cured casing, and then curing the uncured rubber for a time, pressure, and/or temperature desired for curing to bond the tread material with the casing. In various embodiments, a groove or similar mating-enhancing feature may be disposed on the casing and/or the tread material to help in the securing of the tread to the casing. In various embodiments, the edges of the tread may be adapted to fit in a circumferential groove disposed in the casing to help hold the two components in position during the curing process and/or improve the transition between the casing and the tread. In various embodiments, the mating-enhancing feature may impart increased durability and/or decreased likelihood of separation of the casing and the tread material when the tire is in operation.

In various embodiments, the tread material and/or the casing may be buffed or otherwise surface treated prior to the second curing (i.e., after curing the tread material and the casing but prior to curing the uncured rubber to bond the tread material and the casing). Surface treating may include removing a thin layer of tread material and/or casing material by one or more processes including sanding, brushing, grinding, and other means to increase the bondable surface area of the tread material and/or the casing material. Increasing the surface area of rubber, for example, may allow more carbon molecules to be available to react with a curing agent (e.g., chemical cross-linking may be effected by oxygen, sulfur, and/or other curing agents) during the curing operation thereby promoting increased adhesion of the tread material with the casing. Other methods of surface treatment may alternatively be used to help bond the tread material with the casing, depending on the applications.

As mentioned previously, chamber(s) and/or channel(s) may be present in one or both of a tread material and a casing. In various ones of these embodiments, methods may be used to help resist the flow of uncured rubber or other bonding material into the chamber(s) and/or channel(s), which may normally be caused by the temperatures and pressures encountered when coupling a tread material with a casing.

In various embodiments, a tread material may be coupled with a casing using rubber that has been partially cured prior to being placed between a tread material and a casing for further curing. In various ones of these embodiments, partial curing may slow the flow of a rubber material and/or may inhibit flow of the rubber material into chamber(s) and/or channel(s). A number of different processes may be used for partial and/or full curing and may include processes which slows the flow of rubber and/or rubber-based material. In embodiments, rubber may be partially cured through a selected one or more of heat, pressure, and chemical(s). In one embodiment, the material may be irradiated, thereby partially curing the material from the inside towards the outside.

Various other methods may be performed for ensuring a bonding material does not flow into chamber(s) and/or channel(s) when coupling a tread material with a casing. For example, a barrier material may be used. In some embodiments, the barrier material may comprise a woven fabric or fabric-like material including, for example, a leno weave or a square woven fabric. The barrier material may include a rubber or rubber-based material disposed on one or both sides of the barrier material, and the barrier material itself may also be impregnated and/or saturated with an appropriate bonding material. The bonding material may be cured in order to couple a casing with a tread material during a further curing operation. In various ones of these embodiments, curing the bonding material on one or both sides of the barrier material prior to further curing may help resist the flow of bonding material into the chambers and/or channels. A number of operations may be used for partial and/or full curing and may include any operation which slows the flow of bonding materials. In embodiments, partial curing may be effected through a selected one or more of irradiation, heat, pressure, and chemical(s).

In addition to or instead of a barrier material, various other materials may be used to inhibit partial or full closure of chamber(s) and/or channel(s) during a curing operation curing a tread material to a casing. For example, in various embodiments, a lining material may be placed in the recess(es) and/or groove(s) (that will form chamber(s) and/or channel(s) when the tread material and casing are coupled) prior to curing a tread material to a casing to inhibit flow of bonding materials into the formed chamber(s) and/or channel(s). The lining material may be selected from materials resistant to adhesion to tread material, casing, and/or bonding material. In various embodiments, one or more lining materials selected from materials including polyethylene terephthalate (PET) (e.g., Mylar), polytetrafluoroethylene (PTFE) (e.g., Teflon), a pre-cured material (e.g., pre-cured rubber), and a non-curable material. The lining material selected may take any one of a variety of forms including a two-sided film, a hollow tube (e.g., for channels), and a balloon (e.g., for chambers). Still further, it may be advantageous to select an expandable lining material so that the lining material does not inhibit expansion of chamber(s) and/or channel(s).

In various embodiments, it may be necessary or desirable to inhibit expansion of chamber(s) and/or channel(s) that may naturally tend to occur when coupling a tread material with a casing. Inhibiting expansion may be beneficial in the bonding processes where higher heat and/or pressure is used, as this may have the tendency to cause undesirable expansion of chamber(s) and/or channel(s) and a corresponding urging outward of tractive device(s). Some generally known curing operations enlist a curing bag into which a tread material and a casing is inserted and heat and/or pressure is provided to the curing bag resulting in the tread material and casing becoming bonded together. In various embodiments, if expansion of chamber(s) and/or channel(s) is not inhibited, corresponding tractive device(s) may be urged outward possibility resulting in a puncture of the curing bag.

In various embodiments, a filler material may be used to inhibit expansion of chamber(s) and/or channel(s) during a curing operation. The filler material may comprise pre-cured rubber placed into one or more voids in the tread material. The filler material may be adapted such that after the tread material and the casing are bonded, the filler may be removed without damaging the tread material and/or tire.

In another embodiment, to help resist puncture of the curing bag as a result of expanding tractive devices, a secondary curing bag may be used. In such embodiments, a primary curing bag may provide enough resistance to the tractive device(s) being urged outward, and if punctured or the integrity is sacrificed, the secondary curing bag may remain undamaged by the tractive device(s) such that the curing process is not compromised. The secondary curing bag may comprise the same or different material as the material of the primary curing bag.

In yet another embodiment, a puncture-resistant curing container or mold may be used instead of the curing bag system to bond a tread material with a casing. In various ones of these embodiments, the puncture-resistant curing container may be substantially rigid or may be bag-like yet comprised of puncture-resistant material. In one embodiment, the puncture-resistant curing container may comprise a rigid material being hinged to open and close as necessary, thereby resisting the internal pressures that are created to cause the casing and tread to be forced together.

A tire including various features of the present invention may be incorporated into various systems. For example, a system may comprise a tire including a tread material and a casing. The tread material may comprise voids and road-engaging surfaces. The system may further comprise a barrier material disposed between the tread material and the casing.

A system in accordance with various embodiments of the present invention may comprise one or more media transfer conduits coupled with the tire. In various ones of these embodiments, the media transfer conduit(s) may be adapted to connect one or more media passages (including chamber(s) and channel(s)) with a media source. A media source may be adapted to provide a medium to chamber(s), directly and/or via one or more channel(s), causing, at least in part, an expansion of the chamber(s) and/or channels to urge corresponding tractive device(s) outward, as described previously. For example, the media source may be any material capable of being controllable to cause an expansion of chamber(s) and/or channel(s) including air, liquid, etc. In various embodiments, the media passages may be coupled or may be distinct, depending on the desired configuration. Distinct media passages may be advantageous in the event one or more of the media passages becomes blocked so that at least partial tractive capability is retained.

Still further, in various embodiments, a media source may comprise cool air (e.g., air cooler than temperature of the air in and around the tire) or other medium. Tires may have a tendency to experience high temperatures during use, by atmospheric temperature, heat from a vehicle, and/or heat from road/tire engagement. Such high temperatures may contribute at least in part to the deterioration and/or premature wearing of the tires. A cooling medium, such as cool air, may be circulated throughout the chambers and passages in order to reduce the operating temperatures. This in turn may help extend the lifetime of a tire. Circulating a cooling medium may also be capable of helping to lower the potential for heat generated expansion of air inside chamber(s) and/or channel(s) and thus reduce the possibility of the corresponding tractive devices from engaging the road when unnecessary.

A media transfer conduit may be variously configured and may comprise various components. In various embodiments, the media transfer conduit may be configured such that one or more chambers and/or one or more channels are in fluid connection with a media source inside and/or outside of a tire, depending on the applications. In an exemplary embodiment, a media source may be air from air inside a tire or air, liquid or other media from some external source (e.g., external pump, atmospheric air, etc.).

In various embodiments, the media transfer conduit may be coupled to a tire by one or more compression valves in a wall of the casing. The compression valve may be configured to control ingress and/or egress of media into/out of the chamber(s) and/or channel(s). The compression valve may be coupled with the wall of the casing by forming a hole in the wall, inserting the compression valve through the wall, and coupling the compression valve to the wall. In various embodiments, the compression valve may be inserted and/or coupled to the wall using a riveting type tool or similar device, if necessary that may insert the valve through the casing and securely hold it in place before, during and/or after the curing process. In an exemplary embodiment, the compression valve may be coupled to the wall in at least two locations: in a portion of the wall of the casing coupled with the tread material (to provide media to the media passages) and in another location of the casing for coupling the media passages to the atmosphere (or another media source). In one embodiment, placement of the compression valve above the turn-up portion and the flex region may allow the tire to be used on any rim without significant modification, and yet be in a region where there is the lowest flexing of the tire to resist separation and leakage around the valve. In various embodiments, an adhesive may be applied prior to insertion to strengthen a bond between the compression valve and the casing. In one embodiment, a bonding agent such as Chemlok® may be used as the adhesive.

In various embodiments, the media transfer conduit may be further coupled with a solenoid or similar device, a rotary valve, diversion valve, or a similar multi-way valve for controlling media movement. Media movement may be controlled manually and/or automatically (e.g., by frictional change detected by a vehicle's electronic system), and either may be controlled by a wired or wireless signal.

In exemplary embodiments, a media transfer conduit may comprise a solenoid valve which may allow for controlling of the pressure within chamber(s) and/or channel(s) by orienting the valve between at least positions including, for example, (1) such that chamber(s) and/or channel(s) pressurize to a pressure within the tire, and (2) such that chamber(s) and/or channel(s) pressurize to an atmospheric pressure outside the tire. In various embodiments, pressurizing chamber(s) and/or channel(s) to a pressure within the tire may cause chamber(s) to expand causing corresponding tractive device(s) to urge outward. On the other hand, pressurizing chamber(s) and/or channel(s) to an atmospheric pressure may cause chamber(s) and/or channel(s) to move to a position wherein corresponding tractive device(s) are at or below road-engaging surfaces (i.e., the road is engaged fully or mostly by the road-engaging surfaces).

In one embodiment, the actuation of the valve (e.g. solenoid valve, or rotation of a rotary valve) may be manual. In other embodiments, the valve may be actuated/rotated/etc. via remote signal. In such an embodiment, a transceiver may receive such a signal and cause a mechanical and/or electrical actuating mechanism to cause the valve to switch positions, thereby either extending or retracting the studs as desired. In various embodiments, a vehicle may include circuitry adapted to determine whether increased or decreased traction is necessary or desired, wherein the circuitry is further adapted (e.g., via another transceiver) to provide a signal to the transceiver indicating that the rotary valve should be switched. In various embodiments, a control device may be positioned in the car and have a driver interface which allows the driver to control sending of the actuation signal to the valve (for example, somewhat like a garage door opener). In various other embodiments, the control may be in communication with the vehicles on board computer, such that when the vehicle computer detects a loss of traction at one or more tires, a signal can be generated and send to the valve transceiver and cause the valve to rotate to the inflated position.

In one embodiment, the valve may be configured to be such that the media transfer conduit is in normal communication with the atmosphere. When additional traction is needed, the valve rotates or moves such that the media transfer conduit is in communication with the air in the tire, thereby pressurizing chamber(s) and/or channel(s). In various other embodiments, chamber(s) and/or channel(s) may be in an initial pressurized state (i.e., chamber is expanded) and may be controllable to reduce pressure within chamber.

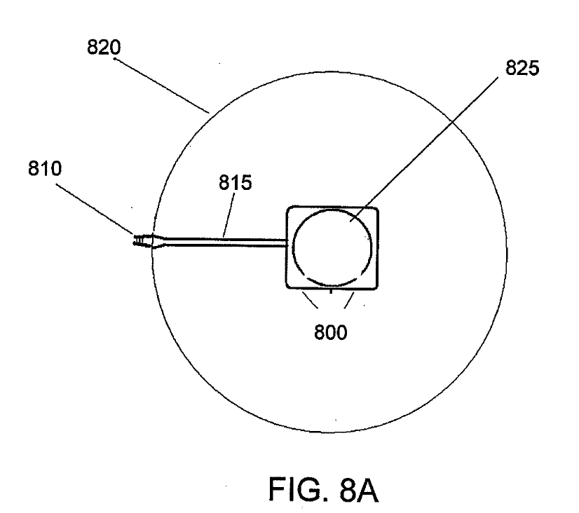

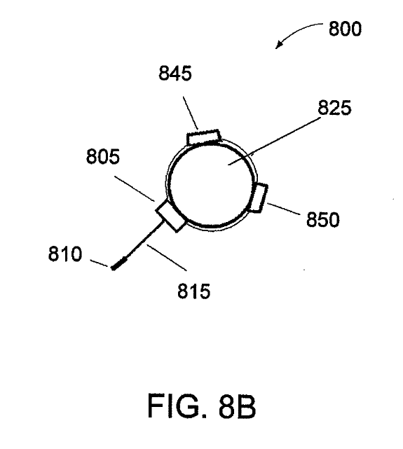

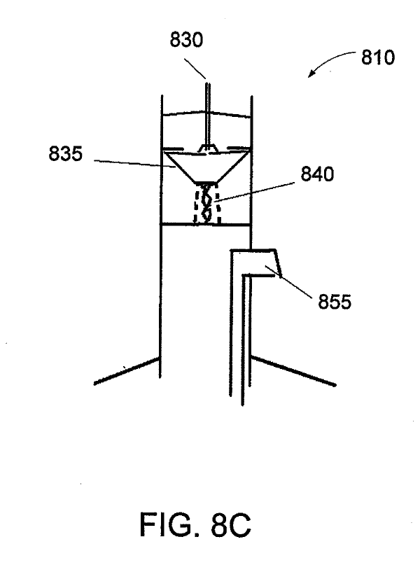

In embodiments wherein air in the tire pressurizes the media passages, for example, the tire may comprise a pump (or compressor). FIGS. 8A, 8B, and 8C illustrate one such embodiment and as shown, pump 805 is coupled to tire valve stem 810 via media transfer conduit 815 and adapted to pull air into the tire from the atmosphere in order to maintain a desired air pressure within the tire. This embodiment may be particularly desirable in situations wherein the chamber(s) (and associated tractive device(s)) are actuated using the air in the tire enough times so as to cause an undesirable reduction of air pressure in the tire.

The pump may be coupled to the wheel rim 820, wheel hub 825, or otherwise disposed in the tire and adapted to pull air into the tire through either an existing valve stem 810 or a separate designated valve stem. In one or both of these embodiments, valve stem 810 may comprise either a typical valve stem (e.g., a Schrader valve, which may also be configured to coupled to an external inflation device to inflate the tire) or may comprise various other types of valve systems, which may include, for example, a plunger tip 830, a seal member 835, and/or a resistance spring 840 (as illustrated in FIG. 8C). In one embodiment, pump 805 may be adapted to cause plunger tip 830 to move to a position to allow atmospheric air to be pulled into the tire by overcoming the resistance of the resistance spring 840.

As illustrated in FIG. 8B, pump 805 (or other media management subsystem) may include or may be coupled to a power source 845, if necessary. Power source 845 may comprise power from a vehicle (e.g., on board battery, etc.), a motion-charged battery disposed in or about the tire, stored solar energy, etc.

Still referring to FIG. 8B, in various embodiments, a media management subsystem may include a heat and/or pressure sensor 850. As mentioned previously, it may be desirable to control temperature in the media passages to extend the lifetime of a tire and/or to control expansion of the chamber(s). Heat and/or pressure sensor(s) 850 may be capable of either communicating any change to a driver (e.g., by some indicator on the dashboard) or to some other device of the media management subsystem capable of controlling heat and/or pressure (e.g., through cooling air, as described above, or an exhaust port, as described below). In various ones of these embodiments, heat and/or pressure sensor(s) 850 may be coupled to a transceiver or similar device to communicate appropriate information.

In various embodiments, the valve controlling the pressurization and depressurization of the air channels may be coupled to a separate exhaust port 855 disposed within or adjacent to the existing valve stem 810 of the tire, as illustrated in FIG. 8C. In one embodiment, exhaust port 855 or channel may be integrated within valve stem 810, and be configured to allow air from the chamber(s) and/or channel(s) to exhaust to the atmosphere. In one embodiment, the exhaust port 855 may be coupled to the valve, such that upon appropriate actuation of valve, the passages and chambers are in communication with the exhaust port 855, such that pressurized air in the chambers and passages may exhaust to the atmosphere.

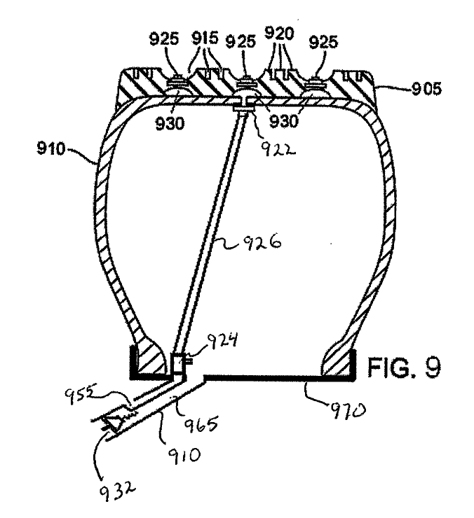

FIG. 9 illustrates a tire in accordance with an embodiment of the present invention. A tread material 905 may be cured to casing 910, which in turn may be mounted on rim 970. Chambers 930 and channels (not shown) may be disposed substantially below voids. Tractive devices 925 may be coupled to chambers 930 and/or channels (not shown) and adapted to extend and retract depending on inflation and deflation of the chambers 930 and/or channels (not shown).

A channel or chamber port 922 may be coupled to one or more chambers 930 and/or channels and adapted to allow media to pass into the chambers and/or channels and out through the casing 910. A control valve 924 may be coupled to the port 922 by way of media transfer conduit 926.

In various embodiments, control valve 924 may be adapted to control the passage of pressurized air from inside the tire to the channels and/or chambers 930 to cause, at least in part, extension of the tractive members 925, and to also control the passage of air or other media from the channels and chambers 930 to the atmosphere to allow for retraction of the tractive members 925.

In these embodiments and other embodiments, as described previously, control valve 924 may be configured such that the media transfer conduit 926 may be in communication with the atmosphere (i.e., air outside of the tire) via exhaust port 955. “Communication with the atmosphere” may mean that air is permitted to freely move between the atmosphere and the channels and/or chambers 930, or may mean that air within the channels and/or chambers 930 is exhausted as desired and then exhaust port 955 is sealed until some later time (e.g., when exhausting of chambers and/or channels is again desired). In either event, communication with the atmosphere may result in equilibrium with atmospheric pressure and a resultant retraction of the tractive devices 925. When traction is needed, the control valve 924 may be actuated such that it is oriented to allow the media transfer conduit 926 to be in communication with the pressurized air inside the tire, thereby allowing air from inside of the tire to flow to the channels and/or chambers 930, resulting in their pressurization and extension of the tractive devices 925.

Control valve 924 may be coupled to exhaust port 955 disposed in valve stem 910, such that media may pass from the channels and chambers to the atmosphere when retraction of the tractive devices is desired. In various embodiments, though not shown, an internal pump (or compressor) may be coupled to the intake passage 965 of valve stem 910, and adapted to pull air into the tire by way of a conducive valve stem valve 932 configuration, as previously discussed. In various embodiments, control valve 924 may be mounted to the rim 970, while in other embodiments, it may be positioned in other areas in the tire.

As previously discussed, in various embodiments the exhaust port 855 may be positioned on or within any surface of the tire or wheel, and not coupled to the tire's existing valve stem configuration. As further discussed previously, movement of media between the chambers and/or channels and atmosphere may be controlled by a valve configuration such as a solenoid or similar device, a rotary valve, diversion valve, or a similar multi-way valve.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

1. A tire manufacturing method, comprising:
forming a tread pattern in a first side of a tread material, the tread pattern including a plurality of road-engaging surfaces and a plurality of voids;
bonding a casing with a second side of the tread material;
forming a plurality of chambers between the tread material and the casing substantially under one or more of the voids; and
forming one or more channels between the tread material and the casing substantially under one or more of the voids to interconnect two or more chambers.

2. The method of claim 1, further comprising placing one or more tractive devices in one or more of the voids having corresponding one or more chambers and/or one or more channels generally thereunder.

3. The method of claim 2, wherein the placing one or more tractive devices comprises placing one or more tractive devices in one or more of the voids during the forming of the road-engaging surfaces and the voids.

4. The method of claim 2, wherein the placing one or more tractive devices comprises applying an adhesive material on a selected one or more of the tractive devices and the one or more of the voids, and placing the tractive devices in the one or more of the voids during the forming of the road-engaging surfaces and the voids.

5. The method of claim 1, wherein the bonding the casing with the second side of the tread material comprises coupling a first mating-enhancing feature of the tread material with a second mating-enhancing feature of the casing.

6. The method of claim 1, wherein the bonding the casing comprises bonding the casing with the second side of the tread material inside of a curing container.

7. The method of claim 6, wherein bonding the casing with the second side of the tread material inside of a selected one of two or more curing bags and a puncture-resistance curing mold.

8. The method of claim 1, wherein the bonding the casing comprises bonding the casing with the second side of the tread material using a rubber-based material.

9. The method of claim 8, wherein the bonding comprises curing the rubber-based material to bond the casing with the second side of the tread material.

10. The method of claim 9, further comprising partially curing the rubber based material prior to bonding the tread material to the casing to help resist the flow of the rubber based material into the chambers and/or the channels.

11. The method of claim 10, wherein the partially curing the rubber-based material includes irradiating the rubber based material.

12. The method of claim 9, further comprising placing a lining material and/or a filler material in the chambers and/or the channels to resist the adhesion of the rubber-based material to a surface of the chambers and/or the channels.

13. The method of claim 9, further comprising placing a barrier material between the casing and the second side of the tread material to resist the flow of the rubber-based material into the chambers and/or the channels.

14. The method of claim 13, wherein the placing the barrier material between the casing and the tread material comprises placing a woven material between the casing and the tread material.

15. The method of claim 14, wherein the placing a woven material between the casing and the tread material comprises placing a selected one of a leno weave material and a square woven fabric between the casing and the tread material.

16. The method of claim 1, further comprising buffing the tread material and/or the casing prior to bonding.

17. The method of claim 1, further comprising coupling a valve with the casing to control ingress and/or egress between one or more of the chambers and/or channels and one or more media sources.

18. The method of claim 17, wherein the coupling the valve comprises applying an adhesive onto the valve and inserting the valve through a wall of the casing.

19. A tire tread manufacturing method, comprising:
providing a tread material having a first side and a second side opposite the first side;
forming, on the first side, a plurality of road-engaging surfaces and a plurality of voids; and
forming, on the second side and under one or more of the voids, a plurality of recesses and one or more grooves to interconnect two or more of the recesses.

20. The method of claim 19, further comprising placing one or more tractive devices in one or more of the voids having corresponding one or more chambers and/or one or more channels thereunder

21. The method of claim 20, wherein the placing the one or more tractive devices comprises placing the one or more tractive devices in the one or more of the voids having corresponding one or more recesses and/or one or more grooves there under during the forming of the road-engaging surfaces and the voids.

22. The method of claim 19, wherein the forming the plurality of recesses and the one or more grooves comprises compression molding the plurality of recesses and the one or more grooves.

23. The method of claim 22, wherein the forming the plurality of road-engaging surfaces and the plurality of voids comprises compression molding the plurality of road-engaging surfaces and the plurality of voids simultaneously with compression molding of the plurality of recesses and grooves.

24. The method of claim 23, wherein the compression molding comprises curing the tread material to form the plurality of road-engaging surfaces, the plurality of voids, the recesses and the grooves.

25. The method of claim 19, further comprising forming a membrane between one of the recesses and one of the voids.

26. The method of claim 25, further comprising placing a tractive device in the membrane and curing the tractive device in the membrane during the forming of the tire tread.

27. The method of claim 26, wherein placing the tractive device further includes providing a tractive device having a base portion having a larger lateral surface area than vertical surface area, and curing the base portion in the membrane.

28. A tire casing manufacturing method, comprising:
providing a casing material; and
forming on a surface of the casing material a plurality of recesses and one or more grooves to interconnect two or more of the recesses.

29. The method of claim 28, wherein the forming the plurality of grooves and/or recesses comprises compression molding the plurality of grooves and/or recesses into the surface of the casing material.

30. A method for manufacturing a new tire, comprising:
providing a new casing;
providing a new tread material having a tread pattern, the tread pattern including a plurality of road-engaging surfaces and a plurality of voids; and
bonding the new tread material with the new casing.

31. The method of claim 30, wherein the providing the new casing comprises providing a new casing including a mating-enhancing feature and wherein the bonding the new tread material with the new casing comprises coupling an edge of the tread material to the mating-enhancing feature.

32. The method of claim 30, further comprising buffing a selected one or more of the new casing and the new tread material prior to the bonding.

33. The method of claim 30, further comprising:
forming a plurality of chambers between the new tread material and the new casing substantially under one or more of the voids; and
forming one or more channels between the tread material and the casing substantially under one or more of the voids to interconnect two or more of the chambers.

34. The method of claim 33, further comprising placing one or more tractive devices in one or more of the voids having corresponding one or more chambers and/or one or more channels generally thereunder.

35. The method of claim 30, wherein the bonding the new tread material with the new casing comprises bonding the new tread material with the new casing with a rubber-based material.

36. The method of claim 35, further comprising placing a barrier material between the new tread material and the new casing to resist the flow of the rubber-based material into the chambers and/or the channels.

37. The method of claim 36, wherein the placing a barrier material between the new tread material and the new casing comprises placing a selected one of a leno weave material and a square woven fabric between the new tread material and the new casing.

38. A tire, comprising:
a tread material including a tread pattern on a first side of the tread material, the tread pattern including a plurality of road-engaging surfaces and a plurality of voids;
a casing bonded with a second side of the tread material;
a plurality of chambers disposed between the tread material and the casing and substantially under one or more of the voids; and
one or more channels interconnecting two or more of the chambers, wherein the one or more channels are disposed between the tread material and the casing and substantially under one or more of the voids.

39. The tire of claim 38, further comprising a one or more tractive device disposed in a corresponding one or more membranes disposed between the one or more voids and corresponding underlying one or more chambers and/or one or more channels.

40. The tire of claim 39, wherein expansion of the one or more is controllable to urge movement of the corresponding tractive device.

41. The tire of claim 38, wherein the casing is bonded with the second side of the tread material with a rubber-based material.

42. The tire of claim 41, further comprising a barrier material disposed between the casing and the tread material.

43. The tire of claim 41, wherein a lining material and/or a filler material is disposed at least partially in the chambers and/or channels in order to help resist adhesion of the rubber based material to the chambers and/or channels.

44. A tire tread for coupling with a tire casing, comprising:
a tread material having a first side and a second side;
a tread pattern disposed in the first side and including a plurality of road-engaging surfaces and a plurality of voids; and
a media passage pattern disposed in the second side having a plurality of recesses and one or more grooves interconnecting the recesses, the recesses and grooves disposed substantially under one or more of the voids, and the recesses and grooves generally forming chambers and channels when the tread material is coupled to a casing.

45. The tire tread of claim 44, further comprising one or more membrane portions between the voids and the one or more grooves and/or channels, and one or more tractive devices disposed in the one or more membrane portions

46. The tire tread of claim 45, wherein the one or more membranes are generally bowed towards the casing when the membrane is in a non expanded state.

47. The tire tread of claim 45, wherein one or more tractive device includes a stud having a road engaging end and a base end adapted to be bonded in the membrane during the tire tread formation process, the base end having a lateral surface area and a vertical surface area, the lateral surface area being greater than the vertical surface area.

48. A tire casing for coupling with a tire tread, comprising:
a casing material; and
a media passage pattern disposed in a surface of the casing material and including a plurality of chambers and one or more channels interconnecting two or more of the chambers, the media passage pattern configured to substantially underlie voids of a tread pattern.

49. The tire casing of claim 48, wherein one or more of the chambers comprises one or more recesses disposed in the surface the casing material.

50. The tire casing of claim 48, wherein one or more of the channels comprises one or more grooves disposed in the surface the casing material.

51. A tire system, comprising:
a tire, including:
a tread material including a tread pattern in a first side of the tread material, the tread pattern including a plurality of road-engaging surfaces and a plurality of voids;
a casing bonded with a second side of the tread material; and
one or more media passages disposed between the casing and the tread material including a plurality of chambers and one or more channels interconnecting two or more of the chambers, wherein the chambers and the channels lie substantially under one or more of the voids; and
a media transfer conduit coupled to the one or more of the media passages and one or more media sources.

52. The system of claim 51, wherein the media transfer conduit includes a valve for controlling, at least in part, ingress and/or egress of a media between the media passages and the one or more media sources.

53. The system of claim 52, wherein the valve is remotely and/or manually controlled, such that the valve may be switched from a first position where the media passages are in communication with a first media source to a second position where the media passages are in communication with a second media source.

54. The system of claim 53, wherein the first media source is atmospheric air and the second media source is pressurized air inside the tire.

55. The system of claim 51, wherein the valve is coupled to the vehicle's computer, and the actuation of the valve is responsive to the computer's detection of slippage of the tire.

56. The system of claim 51, further comprising a pump coupled to the media transfer conduit and adapted to pump atmospheric air into the tire.

57. The system of claim 51, further comprising a sensor selected from a temperature sensor and a pressure sensor coupled to the tire.

58. The system of claim 57, wherein the sensor is adapted to cause, at least in part, a corresponding adjustment of the sensed temperature or pressure.

59. The system of claim 51, further comprising an exhaust port coupled to the media transfer conduit and adapted to controllably exhaust a media disposed within one or more of the media passages.

60. The system of claim 59, wherein the tire further includes a valve stem disposed through an opening in the casing and wherein the exhaust port is disposed through the opening.

61. The system of claim 60, wherein a compressor is disposed in the tire and coupled to the valve stem, the compressor adapted to pull air into the tire through the valve stem.

62. The system of claim 53, wherein the valve is remotely controlled by a wireless device having a driver controllable interface.

63. A tractive device for a tire, comprising
a road engaging end; and
a base having a lateral surface dimension and a vertical surface dimension, the lateral surface dimension being greater than the vertical surface dimension, the base being adapted to be cured into a void of a tread pattern on a tire.

64. The tractive device of claim 63, further comprising a stem portion disposed between the road engaging end and the base having a lateral dimension greater than a lateral dimension of the road engaging end but less than the lateral dimension of the base.

65. The tractive device of claim 63, wherein the lateral dimension and the vertical dimension are a selected one of diameter, width, height, and/or area.

66. The tractive device of claim 63, wherein the road engaging end is adapted to engage a portion of a tire tread pattern mold.
